(19) United States
(12) Patent Application Publication
(10) Pub. No.: US 2023/0385968 A1
(43) Pub. Date: Nov. 30, 2023

(54) SYSTEM AND METHOD OF CLAIMING, VERIFYING, RECORDING, AND ENFORCING DIGITAL AIR RIGHTS

(71) Applicant: Digital Air Rights LLC, Valley, NE (US)

(72) Inventors: Conner Austin Dana, Valley, NE (US); Seyedamirhossein Hosseini, San Diego, CA (US)

(21) Appl. No.: 18/321,324

(22) Filed: May 22, 2023

Related U.S. Application Data
(60) Provisional application No. 63/346,068, filed on May 26, 2022.

(51) Int. Cl. G06Q 50/18

(52) U.S. Cl. CPC G06Q 50/184

(57) ABSTRACT

A computing system and computer-implemented method for facilitating an assertion of virtual rights associated with a real property for an assertive entity. The computing system broadly comprises a processing element and a communications element. The computer-implemented method broadly comprises steps of, via the computing system, maintaining a database of virtual rights associated with real properties including the real property, creating a user account corresponding to a virtual rights claimant, associating the user account with the real property, and generating a notice representing the assertion of virtual rights by the assertive entity of the real property.

### RELATED APPLICATIONS

This patent application is a regular utility non-provisional patent application, and claims priority benefit with regard to all common subject matter, of earlier-filed U.S. Provisional Patent Application Ser. No. 63/346,068, entitled “SYSTEM AND METHOD OF CLAIMING, VERIFYING, RECORDING, AND ENFORCING DIGITAL AIR RIGHTS”, and filed on May 26, 2022. The identified earlier-field provisional patent application is hereby incorporated by reference in its entirety into the present application.

### BACKGROUND

Augmented reality, geofencing, and other digital technologies often affect or interfere with usage and enjoyment of real property. For example, a “brick and mortar” retailer may lose sales to a competitor directing advertisements to mobile devices of patrons of the retailer in a geofencing campaign. Virtual rights such as digital air rights have emerged to address such abstract encroachments, but realization of virtual rights associated with real property has heretofore been difficult and hence virtual rights have been largely inconsequential.

### SUMMARY

Embodiments of the present invention solve the above-described and other problems by providing systems and methods for facilitating claiming, verifying, recording, asserting, and enforcing virtual rights associated with a real property.

An embodiment of the present invention is a computer system for facilitating an assertion of virtual rights associated with a real property. The computer system broadly comprises a processing element and a communications element. The processing element is configured to, among other features, maintain a database of virtual rights associated with real properties including the real property, create a user account corresponding to a virtual rights claimant, associated the user account with the real property, and generate a notice representing the assertion of virtual rights by the assertive entity of the real property. The communications element is configured to, among other features, receive, via a network, a signal representative of an instruction to create the user account and a signal representative of data for creating the user account. The communications element is further configured to transmit the notice over the network.

Another embodiment is a computer-implemented method of facilitating an assertion of virtual rights associated with a real property. The method comprises steps of maintaining a database of virtual rights associated with real properties including the real property, creating a user account corresponding to a virtual rights claimant, associating the user account with the real property, and generating a notice representing the assertion of virtual rights by the virtual rights claimant.

This summary is not intended to identify certain features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a schematic diagram of a virtual rights management computer system constructed in accordance with an embodiment of the invention;

FIG. 2 is a computer interface diagram depicting real properties and virtual rights;

FIG. 3 is a block diagram including certain method steps for facilitating the management of virtual rights in accordance with another embodiment of the invention; and

FIG. 4 is a block diagram including certain method steps for managing virtual rights in accordance with another embodiment of the invention.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

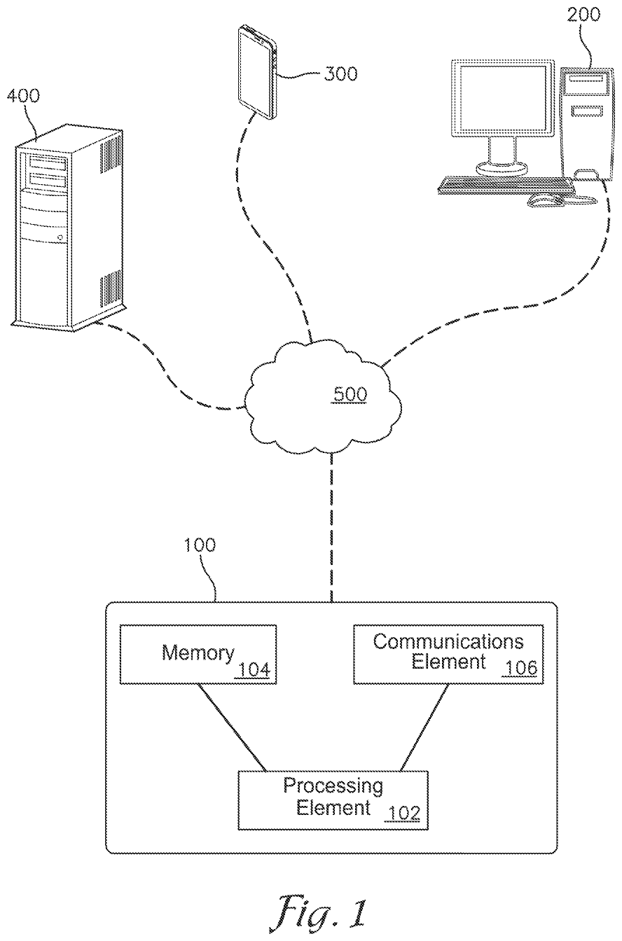

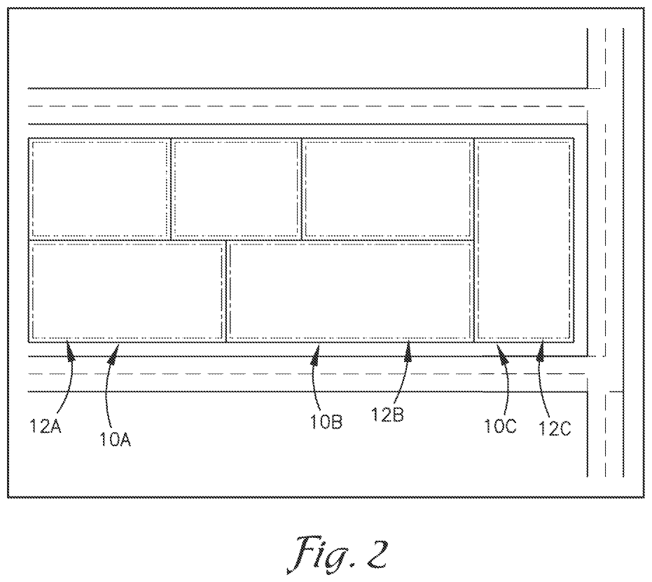

Turning to FIGS. 1 and 2, the present invention provides a computer system 100 and computer-implemented method for facilitating claiming, verifying, recording, asserting, and enforcing virtual rights (e.g., virtual rights 12A-C) associated with real properties (e.g., real properties 10A-C). Virtual rights may include digital air rights, geofencing rights, virtual advertising rights, and other virtual rights associated with real property. The computer system 100 may communicate with several remote computing device such as a remote computing device 200 of a user, business, or other entity owning or asserting virtual rights (hereinafter “assertive entity”), a remote computing device 300 of a prospective virtual rights user or licensee, and a third party computing device 400 (for hosting a third party website) over a wired or wireless network 500.

With particular attention to FIG. 1, the computer system 100 will be described in more detail. The computer system 100 broadly comprises a processing element 102, a memory 104, and a communications element 106. The computer system 100 may be a server, cloud computing device, desktop computer, laptop computer, or the like.

The processing element 102 may include electronic hardware components such as processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 102 may generally execute, process, or run instructions, code, code segments, software, firmware, programs, applications, apps, processes, services, daemons, or the like. The processing element 102 may also include hardware components such as finite-state machines, sequential and combinational logic, and other electronic circuits that can perform the functions necessary for the operation of the current invention. The processing element 102 may be in communication with remote computing devices 200, 300, 400 via a wired or wireless communications network 500.

The memory 104 may be any computer-readable non-transitory medium that can store a program for use by or in connection with an instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The communications element 106 allows the processing element 102 to communicate with the remote computing devices 200, 300, 400 or other electronic devices via the communications network 500. The communications element 106 may include a signal or data transmitting and receiving circuit including components such as an antenna, an amplifier, filters, mixers, oscillators, digital signal processors (DSPs), and the like.

The remote computing device 200 enables the assertive entity to manage the virtual rights via the website. The remote computing device 200 may be a desktop computer, a laptop computer, a tablet, a mobile phone, a digital personal assistant, or the like. The remote computing device 200 may be configured to communicate with the computer system 100 via the communications network 500.

The remote computing device 300 enables a prospective user or licensee of virtual rights to search for, inspect, and enter into agreements for virtual rights via the website. Similar to the remote computing device 200, the remote computing device 300 may be a desktop computer, a laptop computer, a tablet, a mobile phone, a digital personal assistant, or the like.

The third-party computing device 400 may be configured to host a third-party website such as a real estate website or geographical information website. The third-party computing device 400 may be a server, cloud computing device, desktop computer, a laptop computer, a tablet, a mobile phone, a digital personal assistant, or the like.

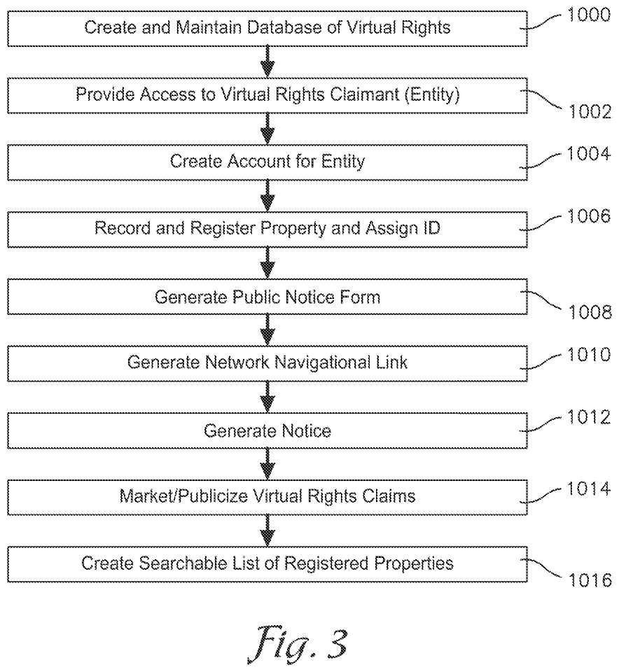

Turning to FIG. 3, and with reference to FIGS. 1 and 2, a method of facilitating claiming, verifying, recording, asserting, and enforcing of virtual rights associated with a real property will now be described in detail. First, a database of virtual rights associated with real properties may be created and maintained, as shown in block 1000. The virtual rights may be auto-populated according to entries of real properties in the database or may be established by property owners visiting the website or accessing the database.

Access to the website may be provided to a property owner or representative of the property owner (i.e., the assertive entity) via the communications element 106, as shown in block 1002. To that end, the assertive entity may access the website via the remote computing device 300.

An account for the assertive entity may then be created by the processing element 102, as shown in block 1004. This may be achieved by the assertive entity requesting the creation of an account via the remote computing device 300. The assertive entity may populate the account with information including assertive entity identity, an address associated with the assertive entity (which may or may not be the same as the property having virtual rights to be enforced), an address or geographic location or description of the property having virtual rights to be enforced, billing information, and other suitable information.

The processing element 102 may then record and register the geographic location or description of the property in the database and assign a unique property identification (ID) or other identifier for the property, as shown in block 1006. The ID may be a number, a code, or the like. The registered property may also be assigned a property notice web page or other publicly accessible computer record.

A public notice form that can be recorded with a county records office for real property, the secretary of state, or other governmental agency may be provided, as shown in block 1008. The public notice form may be licensed for one time use and may be associated with the ID for the property. The legally recorded version of this form may be uploaded back to the website to verify that in fact a legal public notice has been created.

The processing element 102 may then generate a network navigational link for a QR code, bar code, or other reference that links a physical yard sign that can be displayed publicly on the property to the ID for the property and hence the property notice web page, as shown in block 1010. The assertive entity may receive or create the physical yard sign to include the QR code, bar code, or other reference and display the physical yard sign on or near the property.

A notice representing an assertion of virtual rights by the assertive entity may then be generated, as shown in block 1012. For example, claims to the virtual rights or other virtual rights may then be marketed or publicized via the web page and/or other media or via API database map layers provided to third party websites dealing with real estate, as shown in block 1014. The property notice page may allow the assertive entity to identify what rights are available for the property. The assertive entity may, for example, provide a notice that digital or virtual objects may be geolocated on the property, the property may be geofenced and used with digital games or related activities, and the like. The assertive entity may also indicate what activities are prohibited.

A searchable list (e.g., database) of all properties registered per the above steps may be created and maintained on the memory 104 or a remote storage system. Others wishing to seek permission to use virtual rights can research, via the searchable list, who to contact for more information, as shown in block 1016.

### Recording Virtual Rights

As mentioned above, a public notice form that can be recorded with a county records office for real property, the secretary of state, or other governmental agency may be provided to the assertive entity. The public notice form may be reviewed by the assertive entity's legal counsel and recorded by the legal counsel or by a title company.

In addition to facilitating recording the public notice with a county records office or other governmental agency as described above, the operator of the website may allow title companies, realtors, law firms, etc. to integrate the ID or other identifier for the property and the unique virtual rights property notice into property sale closing and recording services. For example, a title company, realtor, or law firm that has registered with the website operator as a licensed channel partner can pay a fee to the web site operator, enter their client's information, prove client consent, and then receive the public notice form with the ID. The title company, realtor, or law firm can then resell the public notice form and ID as part of their service package to their client.

### Licensing, Leasing, and Selling Virtual Rights

A marketing platform may also be provided via the virtual rights website for property owners to lease, license, and sell virtual rights or other virtual rights to others. For example, a property owner who has claimed virtual rights can log into his account and list his property “for lease”. A marketing company may browse (or web crawl) the website and determine that the subject property is available for lease. The marketing company may request an exclusive lease, for example. An exemplary lease may provide rights to render a virtual image, such as an image of a popular soda drink bottle, in the parking lot of the property for a number of days that correspond to an upcoming local sporting event. The website may provide template lease agreements that may be executed by the property owner and the marketing company once they agree upon price and other terms for the lease. In another example, the property owner may decide not to grant an exclusive lease to the parking lot but may instead offer the rights to place virtual objects in designated areas on the property. In a related example, the owner may grant licenses to geofence the property. In another example, the property owner may offer to sell their virtual rights to an investor who may then attempt to monetize the rights.

Another avenue for virtual rights to be licensed and/or traded is via tokenization of the digital air right record public notice form into a nonfungible air rights token. This could allow for peer-to-peer exchanges of the claimed virtual rights and enable a decentralized marketplace. These air rights tokens may allow for royalties to be paid to the original owners every time an exchange is made or other smart contract terms to be introduced.

### Enforcement

The computer system 100, via the website, or other computer systems that implement or partially implement aspects of the invention may also facilitate enforcement of the virtual rights or other virtual property rights. These enforcement mechanisms may include an artificial intelligence agent that scans for advertisements and other geolocated services that are rendered on a property or otherwise associated with a property that is registered with the website or other computer systems that implement the present invention. Such scanning may be accomplished by imitating electronic devices in each location and detecting and logging the various rendering and tracking occurring without permission. insurance with coverage for unauthorized use of a registered property may also be offered via the website. Notices may be sent to detected trespassers with links to the relevant property notice web page so the trespassers may pay any required license or lease fees. The computer system 100 may also geolocate devices on registered properties and track their data activity to verify their usage complies with the property owners virtual rights property notice. The website may also provide a publicly accessible search function that allows the public to determine if a property is in the registry. The website may also enable bulk search access to its private registry database of properties so that advertising firms and others may know which properties have virtual rights or other virtual rights available for lease, license, or sale.

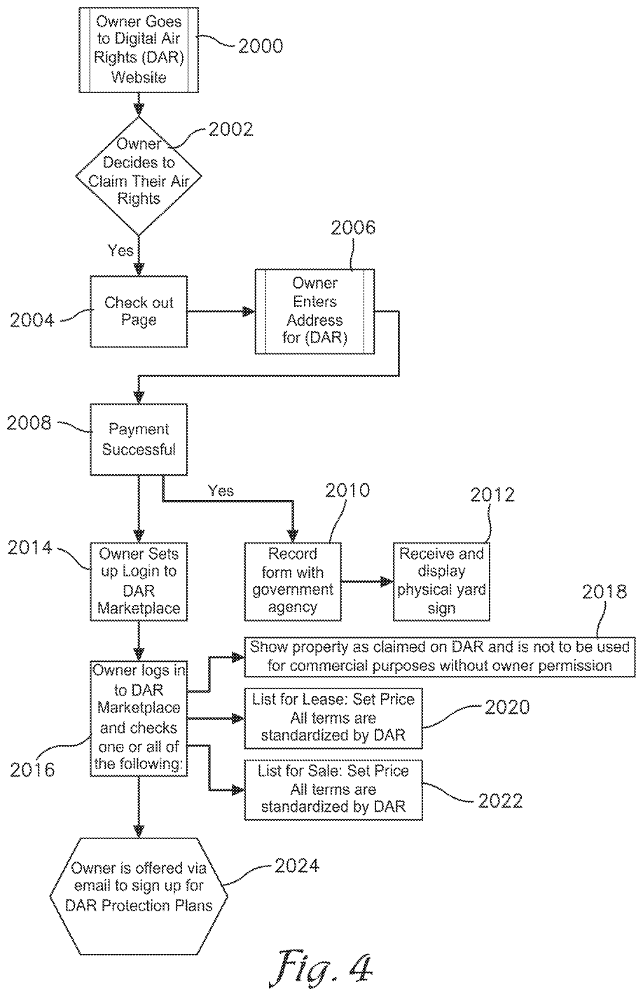

Turning to FIG. 4, a method of claiming, verifying, recording, asserting, and enforcing virtual rights associated with a real property, from an assertive entity's standpoint will now be described in more detail. First, the assertive entity may access the website, as shown in block 2000. This may be done via the remote computing device 200.

The assertive entity may then decide to claim virtual rights associated with their real property, as shown in block 2002. To aid this decision, the assertive entity may use the website to determine virtual rights associated with their real property and virtual rights claiming and enforcing options. For example, the assertive entity may browse the website for a list of virtual rights and view a graphical representation of the real property and the virtual rights, as shown in block 2004.

A search for the assertive entity's real property may be made by entering an address or geographical coordinates of the real property. Alternatively, the assertive entity may select the real property from a list or a map or other graphical representation of the real property, as shown in block 2006.

A payment to the website host may then be made, as shown in block 2008. This may allow the assertive entity to register with the website and receive a public notice form.

The assertive entity may have the public notice form reviewed by their legal counsel and record (optionally via the legal counsel or a title company) the public notice form with a county records office for real property, the secretary of state, or other governmental agency, as shown in block 2010.

The assertive entity may also receive a physical yard sign with a QR code or other link to the webpage associated with the real property and display the physical yard sign on or near the associated property, as shown in block 2012. To that end, the physical yard sign may be mailed to the assertive entity (to an address provided during checkout or to the property). The assertive entity may also receive access to a virtual rights marketplace, among other services and products.

The assertive entity may then set up a login to the virtual rights marketplace, as shown in block 2014. The assertive entity may then log in to the virtual rights marketplace, as shown in block 2016, from which a number of options may be selected. For example, the real property may be shown as claimed on the website and is not to be used for commercial purposes without owner permission, as shown in block 2018. The real property may also be listed for lease and a price for lease may be set. Other terms of the lease may be standardized, as shown in block 2020. The real property may also be listed for sale and a sale price may be set, as shown in block 2022.

The assertive entity may also receive an offer via email or other communication means to sign up for additional benefits. For example, virtual rights protection plans may be offered, as shown in block 2024.

The above-described system and methods provide several advantages. For example, virtual rights can be claimed and asserted in an organized manner on a dedicated platform. Claimants of virtual rights can control how others use digital or virtual representations of spaces related to their real property, thus preventing encroachment of the full enjoyment and use of the real property. It also provides a marketplace for virtual rights, thus enabling their monetization.

### Additional Considerations

The description and drawings are illustrative and are not to be construed as limiting. Numerous specific details are described to provide a thorough understanding. However, in certain instances, well-known or conventional details are not described in order to avoid obscuring the description. References to one embodiment or an embodiment in the present disclosure are not necessarily references to the same embodiment; and, such references mean at least one.

The use of headings herein is merely provided for ease of reference, and shall not be interpreted in any way to limit this disclosure or the following claims.

References to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not for other embodiments. Unless excluded by explicit description and/or apparent incompatibility, any combination of various features described in this description is also included here.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A computing system for facilitating an assertion of virtual rights associated with a real property for an assertive entity, the computing system comprising:
a processing element configured to:
maintain a database of virtual rights associated with real properties including the real property;
create a user account corresponding to the assertive entity;
associate the user account with the real property; and
generate a notice representing the assertion of virtual rights by the assertive entity of the real property; and
a communications element configured to:
receive, via a network, a signal representative of an instruction to create the user account and a signal representative of data for creating the user account; and
transmit the notice over the network.

2. The system of claim 1, the processing element being further configured to assign a unique identifier to the real property and link the unique identifier to the user account to associate the user account with the real property.

3. The system of claim 1, the processing element being further configured to generate a publicly-accessible computer record.

4. The system of claim 3, the publicly-accessible computer record including a downloadable public notice document recordable in a government record.

5. The system of claim 1, the communications element being further configured to receive a signal representative of a mobile computing device query of a physical sign present at the real property, the processing element being further configured direct the query to a database entry associated with the real property.

6. The system of claim 1, the processing element being configured to transmit, via the communications element, a signal representative of the assertion of virtual rights to a third party website.

7. The system of claim 1, the processing element being further configured to tokenize the notice into a nonfungible token.

8. A computer-implemented method of facilitating an assertion of virtual rights associated with a real property for an assertive entity, the computer-implemented method comprising steps of:
maintaining a database of virtual rights associated with real properties including the real property;
creating a user account corresponding to the assertive entity;
associating the user account with the real property; and
generating a notice representing the assertion of virtual rights by the assertive entity of the real property.

9. The method of claim 1, further comprising a step of assigning a unique identifier to the real property, the step of associating the user account with the real property including linking the unique identifier to the user account.

10. The method of claim 1, the step of generating a notice including generating a publicly-accessible computer record including the notice.

11. The method of claim 10, the publicly-accessible computer record being a web site.

12. The method of claim 10, the step of generating a notice including generating a downloadable public notice document recordable in a government record.

13. The method of claim 12, further comprising a step of retaining a copy of the public notice document in recorded form in the database as verification the public notice form has been recorded.

14. The method of claim 1, further comprising directing a mobile computing device query of a physical sign present at the real property to a database entry associated with the real property.

15. The method of claim 1, further comprising a step of publicizing the assertion of virtual rights via a third party website.

16. The method of claim 1, further comprising a step of providing the notice to a third party upon receiving a fee and verifying consent of the assertive entity asserting virtual rights.

17. The method of claim 1, further comprising a step of presenting a marketing platform for leasing, licensing, and selling the virtual rights.

18. The method of claim 1, further comprising a step of tokenizing the notice into a nonfungible token.

19. The method of claim 18, further comprising a step of presenting a decentralized marketplace for the nonfungible token.

20. A computer-implemented method of facilitating an assertion of virtual rights associated with a real property for an assertive entity, the computer-implemented method comprising steps of:
maintaining a database of virtual rights associated with real properties including the real property;
assigning a unique identifier to the real property
creating a user account corresponding to the assertive entity;
associating the user account with the real property by linking the unique identifier to the user account;
generating a publicly-accessible computer record including a notice representing the assertion of virtual rights by the assertive entity of the real property;
generating a downloadable public notice document recordable in a government record;
retaining a copy of the public notice document in recorded form in the database as verification the public notice form has been recorded;
directing a mobile computing device query of a physical sign present at the real property to a database entry associated with the real property;
providing the notice to a third party upon receiving a fee and verifying consent of the assertive entity;
tokenizing the notice into a nonfungible token; and
presenting a decentralized marketplace for the nonfungible token for leasing, licensing, and selling the virtual rights.
